(19) United States
(12) Patent Application Publication
(10) Pub. No.: US 2025/0309428 A1
(43) Pub. Date: Oct. 2, 2025

(54) HIGH VOLTAGE MANIFOLD FOR MULTIPLE CIRCUITS WITH INDIVIDUAL FUSES

(71) Applicant: FCA US LLC, Auburn Hills, MI (US)

(72) Inventor: Mark A Blose, JR., Washington, MI (US)

(21) Appl. No.: 18/616,287

(22) Filed: Mar. 26, 2024

(51) Int. Cl. H01M 50/209; H01M 10/42

(52) U.S. Cl. CPC H01M 50/209; H01M 10/425; H01M 2200/103; H01M 2220/20

(57) ABSTRACT

A high voltage manifold assembly that connects a high voltage battery system to an electrified powertrain for an electrified vehicle is provided. The high voltage manifold assembly includes a battery disconnect unit (BDU), an electrical manifold and a single set of busbars. The BDU is configured to selectively disconnect the high voltage battery from the electrified powertrain. The electrical manifold has a plurality of fuses disposed therein, the plurality of fuses electrically connected to a respective plurality of connectors. The single set of busbars exclusively electrically couple the BDU and the electrical manifold.

### FIELD

The present application generally relates to electrified vehicles and, more particularly, to a high voltage manifold assembly including a battery disconnect unit and electrical manifold for a high voltage battery.

### BACKGROUND

An electrified vehicle (hybrid electric, plug-in hybrid electric, range-extended electric, battery electric, etc.) includes at least one battery system and at least one electronic drive module having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. The high voltage battery system includes a battery disconnect unit (BDU) that has individual busbar circuits from the BDU to several high voltage connectors to exterior sections of the high voltage battery pack. These connections are available to many different device connections in the vehicle. Several busbar circuits within a battery pack requires adequate space that presents weight challenges that adds complexity for assembly and increases cost. Accordingly, while such BDU configurations do work well for their intended purpose, there is a desire for improvement in the relevant art.

### SUMMARY

According to one example aspect of the disclosure, a high voltage manifold assembly that connects a high voltage battery system to an electrified powertrain for an electrified vehicle is provided. The high voltage manifold assembly includes a battery disconnect unit (BDU), an electrical manifold and a single set of busbars. The BDU is configured to selectively disconnect the high voltage battery from the electrified powertrain. The electrical manifold has a plurality of fuses disposed therein, the plurality of fuses electrically connected to a respective plurality of connectors. The single set of busbars exclusively electrically couple the BDU and the electrical manifold.

In some implementations, the electrical manifold includes a body that houses the plurality of fuses therein.

In some implementations, the body is formed of rigid molded plastic.

In some implementations, the electrical manifold includes low voltage wiring that electrically connects the high voltage battery system to a controller of the electrified powertrain.

In some implementations, the plurality of fuses comprises at least three fuses and the respective plurality of connectors comprises at least three connectors.

In additional aspects, the single set of busbars electrically connect with the plurality of fuses and connectors at busbar connections disposed in the electrical manifold.

In additional features, the BDU includes low voltage wiring that electrically connects the high voltage battery system to a controller of the electrified powertrain.

According to one example aspect of the disclosure, a battery pack assembly for an electrified vehicle includes a battery pack housing including an outer wall, at least one battery module and a high voltage manifold assembly. The at least one battery module is disposed within the battery pack housing, wherein a pocket is defined between the outer wall and the at least one battery module. The high voltage manifold assembly connects a high voltage battery system to an electrified powertrain for the electrified vehicle. The high voltage manifold assembly is disposed within the pocket and includes a battery disconnect unit (BDU), an electrical manifold and a single set of busbars. The BDU is configured to selectively disconnect the high voltage battery from the electrified powertrain. The electrical manifold has a plurality of fuses disposed therein, the plurality of fuses electrically connected to a respective plurality of connectors. The single set of busbars exclusively electrically couple the BDU and the electrical manifold.

In additional features, the outer wall comprises a first side wall, a forward wall, and an intermediate wall, wherein the high voltage manifold assembly is disposed in the pocket between the first, forward and intermediate walls and first, second and third and the at least one battery module.

In additional aspects the at least one battery module comprises a first, second and third battery module.

In other aspects, the single set of busbars are routed between a first battery module and the intermediate wall.

In additional features, the electrical manifold includes a body that houses the plurality of fuses therein.

In other aspects, body is formed of rigid molded plastic.

In additional features, the electrical manifold includes low voltage wiring that electrically connects the high voltage battery system to a controller of the electrified powertrain.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a high voltage battery system according to various principles of the present application; and

FIG. 2 is a schematic illustration of a battery disconnect unit (BDU) having multiple busbars routed to respective connectors according to Prior Art;

FIG. 3 is a schematic illustration of a BDU having an electrical manifold electrically connected to the BDU by one set of busbars (single circuit), the electrical manifold including individual fuses electrically connected to respective connectors according to various principles of the present application;

FIG. 4 is top perspective view of an exemplary battery pack assembly that incorporates the BDU, electrical manifold and busbars of FIG. 3 according to various principles of the present application; and

FIG. 5 is side perspective view of the BDU, electrical manifold and busbars of FIG. 4 according to various principles of the present application.

### DESCRIPTION

As discussed above, an electrified vehicle includes a high voltage battery system having a battery disconnect unit (BDU). In prior art configurations, individual busbar circuits connect the BDU to several high voltage connectors on exterior sections of the high voltage battery pack. These connections are available to many different device connections in the vehicle. Several busbar circuits within a battery pack requires adequate space and presents weight challenges that adds complexity for assembly and increases cost.

The instant disclosure provides a BDU having an electrical manifold electrically connected to the BDU by one set of busbars. The electrical manifold includes individual fuses electrically connected to respective connectors extending from the electrical manifold. The configuration of the instant disclose takes the fuses from the BDU and places them closer to the individual high voltage connector circuits allowing a single circuit for power to be routed from the BDU to the electrical manifold. The arrangement allows significant reduction in total busbar routing and simplification of assembly. The electrical manifold busbars can be sized to meet individual power per leg and to meet full power on the common leg of the circuit. The electrical manifold can be a fully contained module, with alignment features for assembly aid, added low voltage connections for sensor, and covers for fuses.

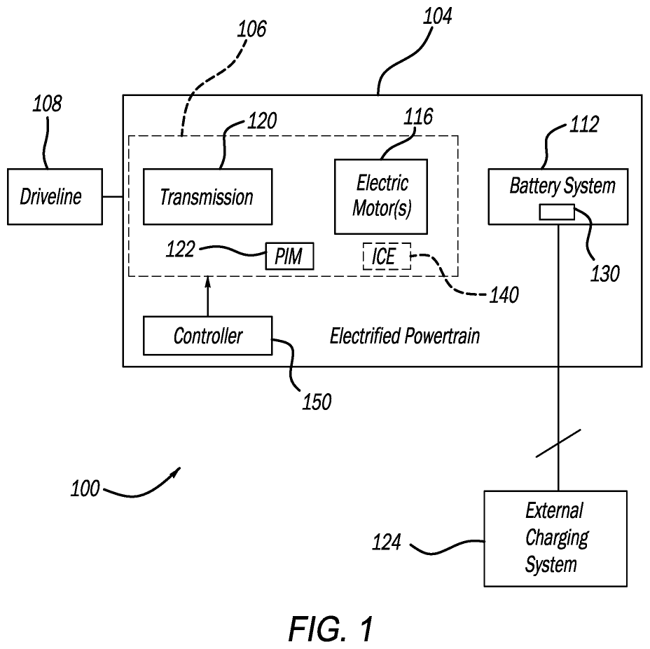

Referring now to FIG. 1, a functional block diagram of an example electrified vehicle 100 (also referred to herein as “vehicle 100”) according to the principles of the present application is illustrated. The vehicle 100 includes an electrified powertrain 104 having an electric drive module (EDM) 106 configured to generate and transfer drive torque to a driveline 108 for vehicle propulsion. The EDM 106 generally includes one or more electric drive units or motors 116 (e.g., electric traction motors), an electric drive gearbox assembly or transmission 120, and power electronics including a power inverter module (PIM) 122.

The electric motor 116 is selectively connectable via the PIM 124 to a high voltage battery system 112 for powering the electric motor 116. The high voltage battery system 112 is selectively connectable (e.g., by the driver) to an external charging system 124 (also referred to herein as “charger 124”) for charging of the battery system 112. The battery system 112 includes at least one battery pack assembly 130. In some examples, the electrified powertrain 104 can be a hybrid powertrain that additionally includes an internal combustion engine 140. A controller 150 can provide various inputs to the EDM 106 related to selectively switching power inputs between the electric motors 116 and, optionally, the ICE 140.

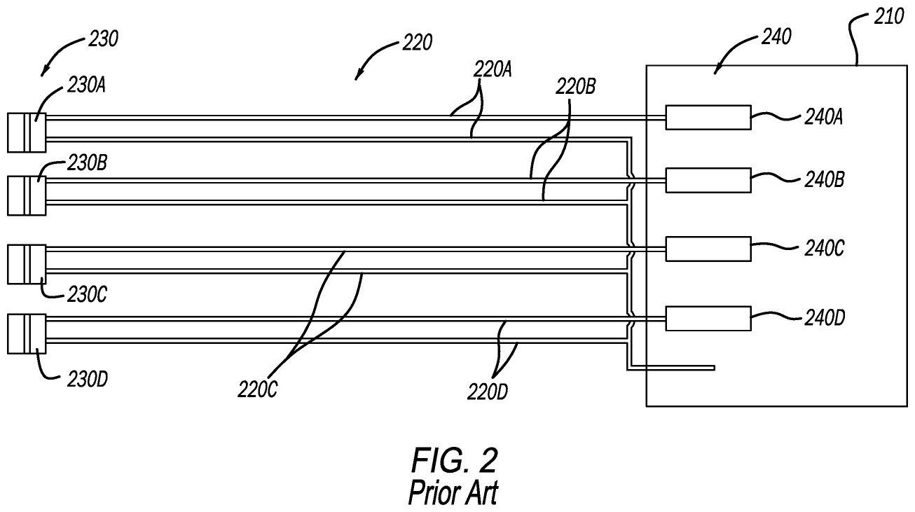

With additional reference now to FIG. 2, a schematic illustration of a battery disconnect unit (BDU) 210 having multiple busbars, collectively identified at 220, routed to respective connectors, collectively identified at 230 according to Prior Art will be described. Fuses, collectively identified at 240 are housed in the BDU 210. The busbars 220 include first, second, third and fourth busbar circuits 220A, 220B, 220C and 220D. It will be appreciated that more busbar circuits can be arranged according to other examples of Prior Art. The connectors 230 include first, second, third and fourth connectors 230A, 230B, 230C and 230D. The first connector 230A is generally connected through the first busbar circuit 220A to a first fuse 240A. The second connector 230B is generally connected through the second busbar circuit 220B to a second fuse 240B. The third connector 230C is generally connected through the third busbar circuit 220C to a third fuse 240C. The fourth connector 230D is generally connected through the fourth busbar circuit 220D to a fourth fuse 240D.

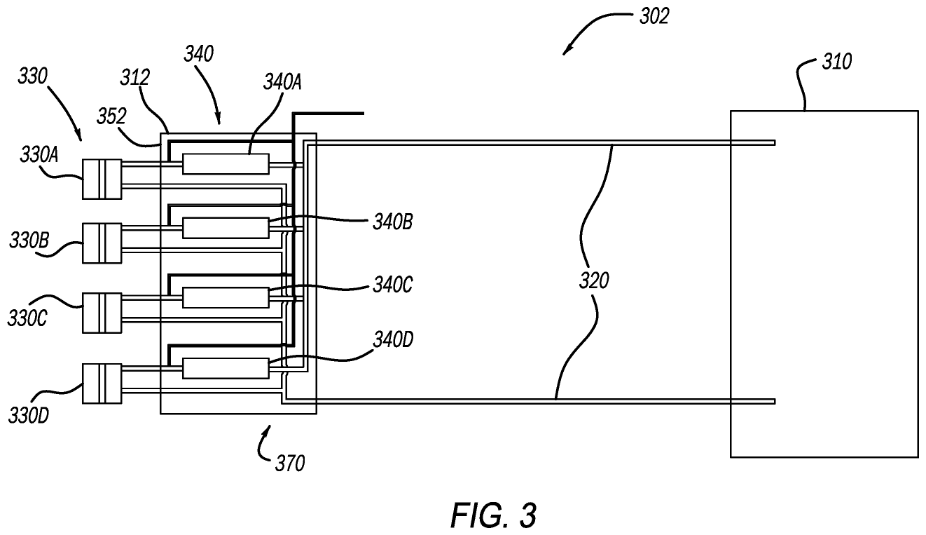

With reference now to FIG. 3, a schematic illustration of a high voltage manifold assembly 302 according to principles of the present disclosure will be described. The high voltage manifold assembly 302 generally includes a BDU 310 electrically coupled to an electrical manifold 312. In general, the BDU 310 performs several functions such as disconnecting the battery system 112 from the electrified powertrain 104 and charging system 124. In examples, the BDU 310 also monitors, activates and deactivates the battery pack assembly 130.

The electrical manifold 312 is electrically connected to the BDU 310 by one set of busbars (single circuit) 320. The electrical manifold 312 includes fuses collectively identified at 340 and individually shown at 340A, 340B, 340C and 340D. The fuses 340 are electrically connected to respective connectors, collectively identified at 330, and individually shown at 330A, 330B, 330C and 330D according to various principles of the present application. The electrical manifold 312 can be a fully contained module, with alignment features for assembly aid, added low voltage connections for sensors and cover(s) for the fuses 340.

The routing of the busbars 320 is simpler as compared to the busbars 220 shown in FIG. 2. In this regard, a single busbar circuit 320 is routed between the BDU 310 and the electrical manifold 312 while still accommodating full power. The busbar connections, collectively identified at 370, within the electrical manifold 312 can be sized for the individual circuit and connector interface. Additionally, unique fuse sizing of the circuits can be provided. The fuses 340 are housed in the body 352 of the manifold 312. In this regard, the fuses 340 are moved closer to the respective connectors 330.

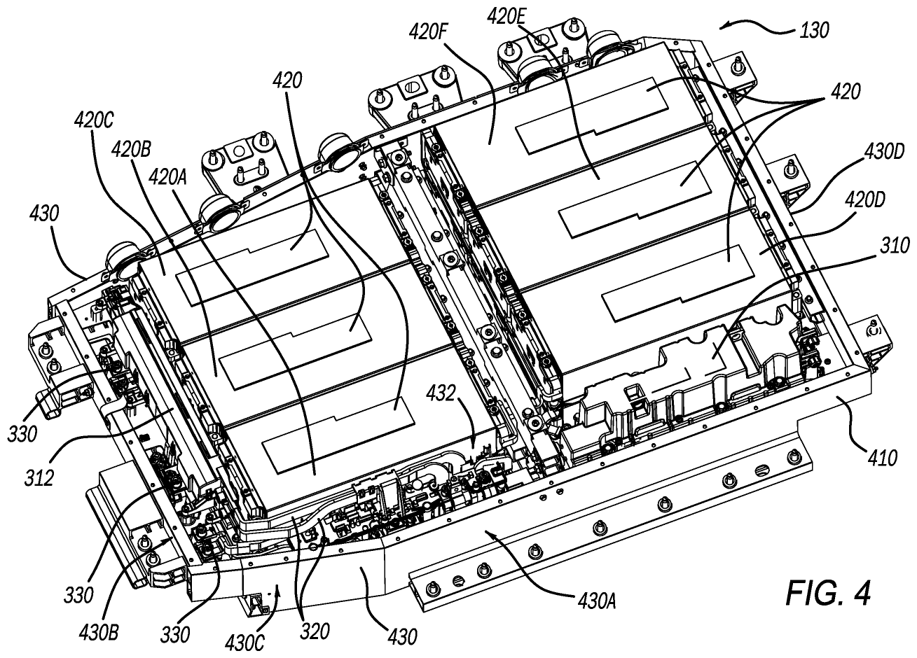

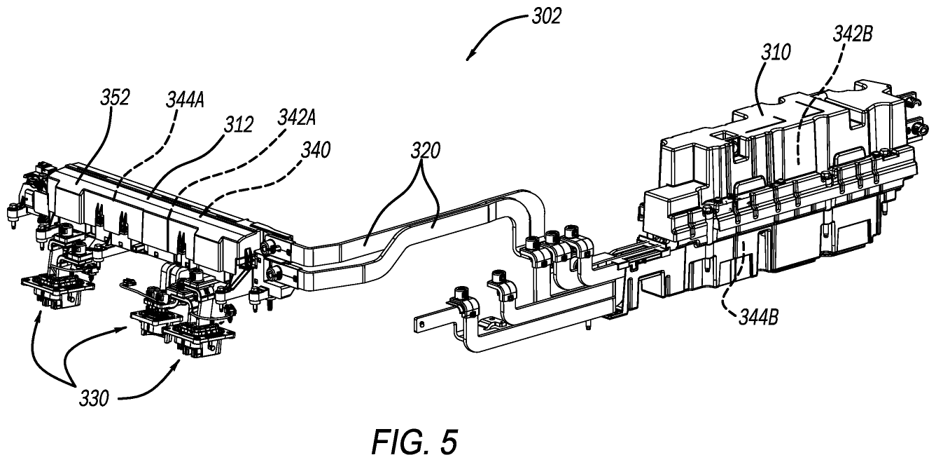

With additional reference to FIGS. 4 and 5 additional features of the high voltage manifold assembly 302 of the instant disclosure will be described. FIG. 4 is top perspective view of an exemplary battery pack assembly 130 that incorporates the BDU 310, electrical manifold 312 and busbars 320 of FIG. 3 according to various principles of the present application. In examples, the sensors 342A in the electrical manifold 312 can be bundled in the electrical manifold 312 to pack as a single unit allowing for easier installation. Sensor functions include, but are not limited to, isolation check and fuse function confirmation. The electrical manifold 312 includes low voltage wiring 344A that connects a main battery pack harness connecting to the controller 150 and other components. The electrical manifold 312 generally includes a structural body and/or cover 352. In examples, the structural body 352 is formed of rigid molded plastic material.

The BDU 310 can also include sensors 342B including, but not limited to, current sensors, high-voltage sensors, temperature sensors and voltage sensors. The BDU 310 includes low voltage wiring 344B that connects a main battery pack harness connecting to the controller 150 and other components. The battery pack assembly 130 generally includes a battery pack housing 410 that houses a plurality of battery modules collectively identified at 420 and individually identified at 420A-420F.

The battery pack housing 410 generally includes an outer wall, collectively identified at reference numeral 430. A groove or pocket 432 is generally defined between the outer wall 430 and the battery modules 420. The pocket 432 generally accommodates the high voltage manifold assembly 302. More specifically, the outer wall 430 is defined by a first or side wall 430A, a second or forward wall 430B and a third or intermediate wall 430C, a fourth or rear wall 430D and a fifth or second side wall 430E.

In an assembled position, the BDU 310 generally occupies a space in the battery housing 410 between the side, rear and intermediate walls 430A, 430D, and 430C and battery modules 420A and 420D. The manifold 312 generally occupies a space in the battery housing 410 between the front wall, intermediate wall and second side wall 430B, 430C and 430E, and the battery modules 420A, 420B and 420C, respectively. The busbars 320 are generally routed between the battery module 420A and the side wall, intermediate wall and front wall 430A, 430C and 430B, respectively. Again, as described above, the instant configuration requires less space within the battery pack housing 410 to accommodate the high voltage manifold assembly 302 as compared to prior art configurations. For example, as only a single busbar circuit 320 is needed between the BDU 310 and the manifold 312, less space is required in the pocket 432 between the outer wall 430 and the battery modules 420. In examples, the manifold 312 generally occupies a space close to the location of the connectors 330, which are generally at the front or rear of the battery pack 130.

FIG. 5 is side perspective view of the BDU 310, electrical manifold 312 and busbars 320 of FIG. 4. If note, the single busbar circuit 320 provides the sole physical connection between the BDU 310 and the electrical manifold 312.

Packaging space is difficult to come by in high-voltage battery packs with the main design focus of battery packs being energy storage. Cells or modules are typically laid out in a design first leaving the BDU not in an optimal location for busbar routing. The present disclosure improves upon this condition by requiring only one busbar set therefore reducing the amount of total busbars required compared to Prior Art configurations that need multiple individual busbar circuits coming from the BDU.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A high voltage manifold assembly that connects a high voltage battery system to an electrified powertrain for an electrified vehicle, the high voltage manifold assembly comprising:
a battery disconnect unit (BDU) configured to selectively disconnect the high voltage battery from the electrified powertrain;
an electrical manifold having a plurality of fuses disposed therein, the plurality of fuses electrically connected to a respective plurality of connectors; and
a single set of busbars that exclusively electrically couple the BDU and the electrical manifold.

2. The high voltage manifold assembly of claim 1, wherein the electrical manifold includes a body that houses the plurality of fuses therein.

3. The high voltage manifold assembly of claim 2, wherein the body is formed of rigid molded plastic.

4. The high voltage manifold assembly of claim 2, wherein the electrical manifold includes low voltage wiring that electrically connects the high voltage battery system to a controller of the electrified powertrain.

5. The high voltage manifold assembly of claim 1, wherein the plurality of fuses comprises at least three fuses and the respective plurality of connectors comprises at least three connectors.

6. The high voltage manifold assembly of claim 1, wherein the single set of busbars electrically connect with the plurality of fuses and connectors at busbar connections disposed in the electrical manifold.

7. The high voltage manifold assembly of claim 2, wherein the BDU includes low voltage wiring that electrically connects the high voltage battery system to a controller of the electrified powertrain.

8. A battery pack assembly for an electrified vehicle, the battery pack assembly comprising:
a battery pack housing including an outer wall;
at least one battery module disposed within the battery pack housing, wherein a pocket is defined between the outer wall and the at least one battery module; and
a high voltage manifold assembly that connects a high voltage battery system to an electrified powertrain for the electrified vehicle, the high voltage manifold assembly disposed within the pocket and comprising:
a battery disconnect unit (BDU) configured to selectively disconnect the high voltage battery from the electrified powertrain;
an electrical manifold having a plurality of fuses disposed therein, the plurality of fuses electrically connected to a respective plurality of connectors; and
a single set of busbars that exclusively electrically couple the BDU and the electrical manifold.

9. The battery pack assembly of claim 8, wherein the outer wall comprises:
a first side wall, a forward wall, and an intermediate wall, wherein the high voltage manifold assembly is disposed in the pocket between the first, forward and intermediate walls and first, second and third and the at least one battery module.

10. The battery pack assembly of claim 9, wherein the at least one battery module comprises a first, second and third battery module.

11. The battery pack assembly of claim 8, wherein the single set of busbars are routed between a first battery module and the intermediate wall.

12. The battery pack assembly of claim 8, wherein the electrical manifold includes a body that houses the plurality of fuses therein.

13. The battery pack assembly of claim 12, wherein the body is formed of rigid molded plastic.

14. The battery pack assembly of claim 12, wherein the electrical manifold includes low voltage wiring that electrically connects the high voltage battery system to a controller of the electrified powertrain.
